(19) United States
(12) Patent Application Publication
(10) Pub. No.: US 2023/0239406 A1
(43) Pub. Date: Jul. 27, 2023

(54) COMMUNICATION SYSTEM

(71) Applicants: KABUSHIKI KAISHA TOSHIBA, Minato-ku, Tokyo (JP); TOSHIBA DIGITAL SOLUTIONS CORPORATION, Kawasaki-shi, Kanagawa (JP)

(72) Inventor: Atsushi KAKEMURA, Kokubunji Tokyo (JP)

(73) Assignees: KABUSHIKI KAISHA TOSHIBA, Minato-ku, Tokyo (JP); TOSHIBA DIGITAL SOLUTIONS CORPORATION, Kawasaki-shi, Kanagawa (JP)

(21) Appl. No.: 18/013,361

(22) PCT Filed: Mar. 16, 2021
(86) PCT No.: PCT/JP2021/010478

§ 371 Date: Dec. 28, 2022

(30) Foreign Application Priority Data
Jun. 30, 2020 (JP) 2020-112963

(51) Int. Cl. H04M 3/56; G10L 13/02

(52) U.S. Cl. CPC H04M 3/564; G10L 13/02

(57) ABSTRACT

A communication system includes a group calling controller configured to perform first processing of broadcasting utterance voice data received from one of mobile communication terminals to other mobile communication terminals and second processing of chronologically accumulating the result of utterance voice recognition from voice recognition processing on the received utterance voice data as a communication history and allowing users to see the communication history in synchronization, and an individual calling controller configured to transmit utterance voice data only to a specified user during group calling. A communication controller including the controllers is configured to identify a user participating in an individual calling mode that utterance voice data being transmitted only to the specified user during the broadcast of the first processing and to perform, after end of the individual calling mode, processing for notifying the identified user that the broadcast was performed during the individual calling mode.

### TECHNICAL FIELD

Embodiments of the present invention relate to a technique for assisting in communication using voice and text (for sharing of recognition, conveyance of intention and other purposes).

### BACKGROUND ART

Communication by voice is performed, for example, with transceivers. A transceiver is a wireless device having both a transmission function and a reception function for radio waves and allowing a user to talk with a plurality of users (to perform unidirectional or bidirectional information transmission). The transceivers can find applications, for example, in construction sites, event venues, and facilities such as hotels and inns. The transceiver can also be used in radio-dispatched taxis, as another example.

### PRIOR ART DOCUMENT

### Patent Document

[Patent Document 1] Japanese Patent No. 4780397

### DISCLOSURE OF THE INVENTION

### Problems to be Solved by the Invention

It is an object of the present invention to provide a communication system capable of coordinated operation of group calling performed among a plurality of users within a communication group and individual calling performed between two of those users.

### Means for Solving the Problems

In a communication system according to embodiments, a plurality of users carry their respective mobile communication terminals, and the voice of utterance of one of the users input to his mobile communication terminal is broadcast to the mobile communication terminals of the other users. The communication system includes a communication control section including a group calling control section configured to perform first processing of broadcasting utterance voice data received from one of the mobile communication terminals to the other mobile communication terminals and second processing of chronologically accumulating the result of utterance voice recognition from voice recognition processing on the received utterance voice data as a communication history and controlling text delivery such that the communication history is displayed on the mobile communication terminals in synchronization, and an individual calling control section configured to transmit utterance voice data only to a specified user included in a communication group in which the broadcast is performed. The communication control section is configured to identify a user participating in an individual calling mode that utterance voice data being transmitted only to the specified user during the broadcast of the first processing and to perform, after end of the individual calling mode, processing for notifying the identified user that the broadcast was performed during the individual calling mode.

### BRIEF DESCRIPTION OF THE DRAWINGS

FIG. 1 A diagram showing the configuration of a network of a communication system according to Embodiment 1.

FIG. 2 A block diagram showing the configurations of a communication management apparatus and a user terminal according to Embodiment 1.

FIG. 3 A diagram showing exemplary user information and exemplary group information according to Embodiment 1.

FIG. 4 A diagram showing exemplary screens displayed on user terminals according to Embodiment 1.

FIG. 5 A diagram for explaining exemplary calling mode coordination processing performed during a group calling mode in response to an interrupt for an individual calling mode according to Embodiment 1.

FIG. 6 A diagram showing a flow of processing performed in the communication system according to Embodiment 1.

FIG. 7 A diagram showing a flow of processing based on a first case performed in a communication system according to Embodiment 1.

FIG. 8 A diagram showing exemplary display of an individual calling history according to Embodiment 1.

FIG. 9 A block diagram showing the configurations of a communication management apparatus and a user terminal according to Embodiment 2.

FIG. 10 A diagram for explaining exemplary calling mode coordination processing performed during a group calling mode in response to an interrupt for an individual calling mode according to Embodiment 2.

FIG. 11 A diagram for explaining another exemplary calling mode coordination processing performed during the group calling mode in response to an interrupt for the individual calling mode according to Embodiment 2.

FIG. 12 A diagram showing a flow of processing based on a second case performed in a communication system according to Embodiment 2.

FIG. 13 A diagram showing the configuration of a network of a communication system according to Embodiment 3.

FIG. 14 A diagram showing exemplary specified notification setting information according to Embodiment 3.

FIG. 15 A diagram showing a flow of processing based on a third case performed in a communication system according to Embodiment 3.

### MODE FOR CARRYING OUT THE INVENTION

### Embodiment 1

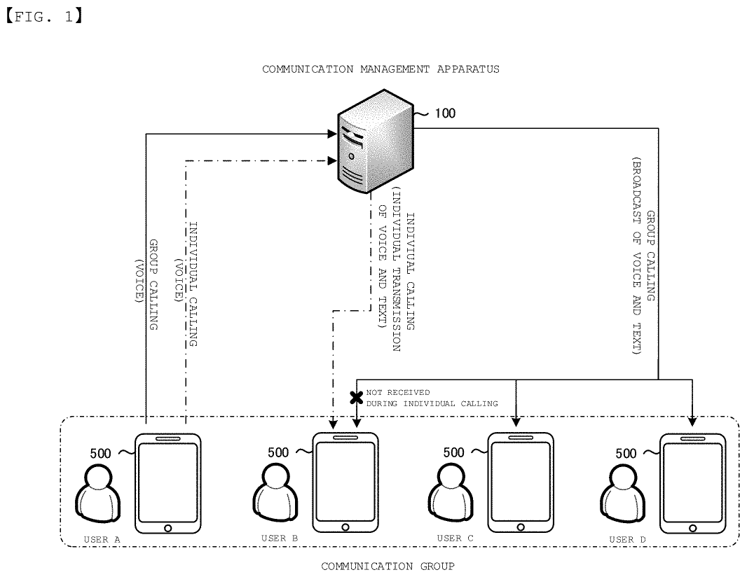

FIGS. 1 to 8 are diagrams for explaining Embodiment 1. FIG. 1 shows the configuration of a network of a communication system according to Embodiment 1. The communication system provides an information transmission assistance function with the use of voice and text such that a communication management apparatus (hereinafter referred to as a management apparatus) 100 plays a central role.

The management apparatus 100 is connected to user terminals (mobile communication terminals) 500 carried by respective users through wireless communication and broadcasts utterance voice received from one of the user terminals 500 to the other user terminals 500.

The user terminal 500 may be a multi-functional cellular phone such as a smartphone, or a portable terminal (mobile terminal) such as a Personal Digital Assistant (PDA) or a tablet terminal. The user terminal 500 has a communication function, a computing function, and an input function, and connects to the management apparatus 100 through wireless communication over the Internet Protocol (IP) network or Mobile Communication Network to perform data communication.

A communication group is set to define the range in which the utterance voice of one of the users can be broadcast to the user terminals 500 of the other users (or the range in which a communication history, later described, can be displayed in synchronization). Each of the user terminals 500 of the relevant users is registered in the communication group.

The communication system according to Embodiment 1 assists in information transmission for sharing of recognition, conveyance of intention and other purposes based on the premise that the plurality of users can perform hands-free interaction with each other. An aspect of applying the communication system to management of facilities is described below, by way of example. In addition to the chain of interaction in the facilities, the communication system can facilitate information transmission in various chains of interaction to help users to contact each other.

The communication system according to Embodiment 1 provides a group calling mode in which a plurality of users simultaneously make calls and an individual calling mode in which specified users of them make calls, and achieves environments capable of coordination between those calling modes.

For example, as shown in FIG. 1, utterance voice from one of the users is sent to the other users in the group calling mode. In the individual calling mode in which one-to-one calling is performed between two specified users, interrupt calling can be performed to make a voice call which only the two users can hear during the group calling mode maintained in the overall communication group.

A communication channel in the group calling mode (group calling channel) and a communication channel in the individual calling mode (individual calling channel) are controlled as different calls. During the individual calling mode, the two participating users cannot hear any voice utterance in the “call” of the group calling mode and utterance voice data delivered simultaneously to the users of the group calling mode, as in normal phone calls. During the group calling mode, the participating users cannot hear any utterance voice data sent between the two users in the “call” of the individual calling mode. In other words, each of the users cannot hear the content in the calling mode (the other call) different from the calling mode in which he is participating.

When a user is in the individual calling mode and another user performs an utterance in the group calling mode, the former user cannot hear the content of that utterance and thus cannot recognize the fact of the utterance.

To address this, the communication system according to Embodiment 1 provides a calling mode coordination function of notifying a user calling in one of the calling modes that an utterance is performed in the other calling mode.

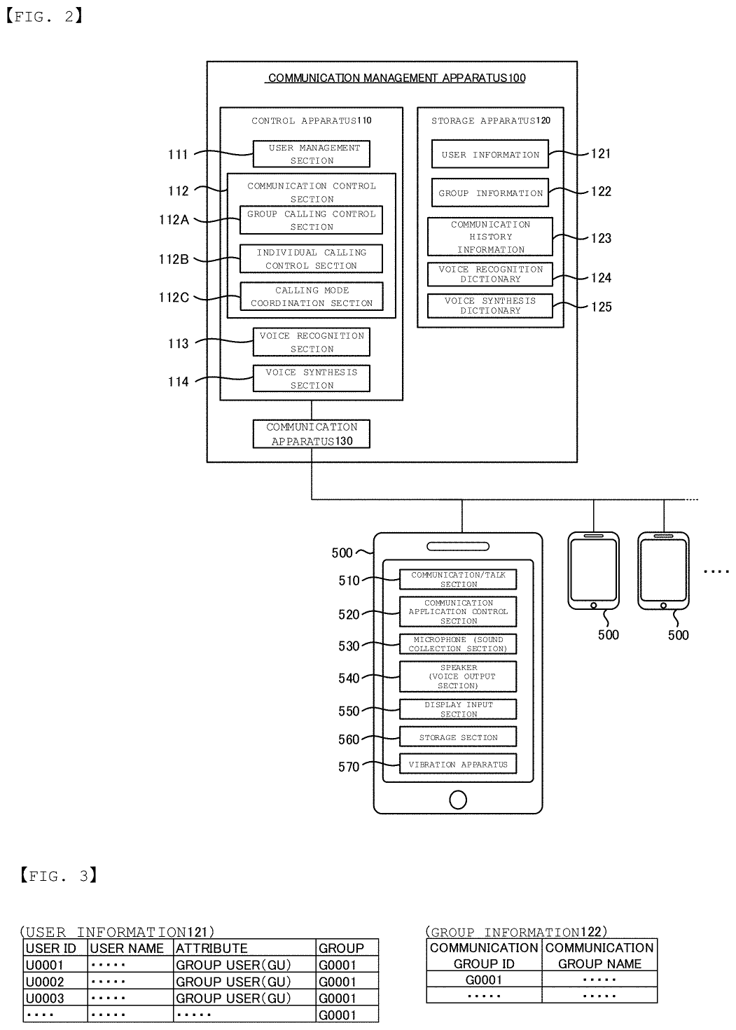

FIG. 2 is a block diagram showing the configurations of the management apparatus 100 and the user terminal 500.

The management apparatus 100 includes a control apparatus 110, a storage apparatus 120, and a communication apparatus 130.

The communication apparatus 130 manages communication connection and controls data communication with the user terminals 500. The communication apparatus 130 controls broadcast to distribute utterance voice data from one of the users and text information representing the content of the utterance (text information provided through voice recognition processing on the utterance voice data) to the user terminals 500 at the same time for a group calling function. The communication apparatus 130 also controls individual transmission to send utterance voice data between specified users (individual calling users) for an individual calling function. The individual transmission control can also transmit text information representing the content of the utterance performed during the individual calling mode to the individual calling users.

The control apparatus 110 includes a user management section 111, a communication control section 112, a voice recognition section 113, and a voice synthesis section 114. The storage apparatus 120 includes user information 121, group information 122, communication history (communication log) information 123, a voice recognition dictionary 124, and a voice synthesis dictionary 125.

The voice synthesis section 114 and the voice synthesis dictionary 125 provides a voice synthesis function of receiving a character information input of text form on the user terminal 500 or a character information input of text form on an information input apparatus other than the user terminal 500 (for example, a mobile terminal or a desktop PC operated by a manager, an operator, or a supervisor), and converting the character information into voice data. The voice synthesis section 114 and the voice synthesis dictionary 115 also provide a voice synthesis function of converting character information previously provided (or created) in the management apparatus 100 into voice data.

However, the voice synthesis function in the communication system according to Embodiment 1 is an optional function. In other words, the communication system according to Embodiment 1 may not have the voice synthesis function. When the voice synthesis function is included, the communication control section 112 of the management apparatus 100 receives text information input on the user terminal 500, and the voice synthesis section 114 synthesizes voice data corresponding to the received text characters with the voice synthesis dictionary 125 to produce synthesized voice data. The synthesized voice data can be produced from any appropriate materials of voice data. The synthesized voice data and the received text information can be broadcast to the other user terminals 500. This operation is similarly performed on the character information previously provided (or created) in the management apparatus 100.

The user terminal 500 includes a communication/talk section 510, a communication application control section 520, a microphone 530, a speaker 540, a display input section 550 such as a touch panel, and a storage section 560. The speaker 540 is actually formed of earphones or headphones (wired or wireless). A vibration apparatus 570 is an apparatus for vibrating the user terminal 500.

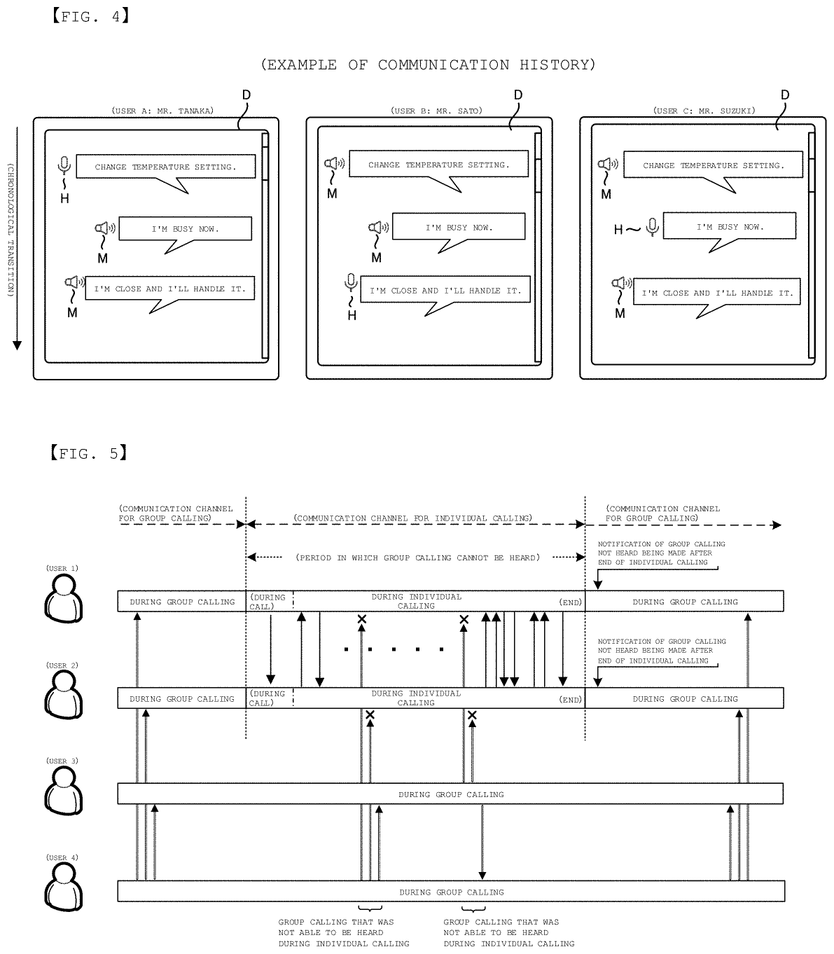

FIG. 3 is a diagram showing examples of various types of information. User information 121 is registered information about users of the communication system. The user management section 111 controls a predetermined management screen to allow setting of a user ID, user name, attribute, and group on that screen. The user management section 111 manages a list of correspondences between a history of log-ins to the communication system on user terminals 500, the IDs of the users who logged in, and identification information of the user terminals 500 of those users (such as MAC address or individual identification information specific to each user terminal 500).

Group information 122 is group identification information representing separated communication groups. The communication management apparatus 100 controls transmission/reception and broadcast of information for each of the communication groups having respective communication group IDs to prevent mixed information across different communication groups. Each of the users in the user information 121 can be associated with the communication group registered in the group information 122.

The user management section 111 according to Embodiment 1 controls registration of each of the users and provides a function of setting a communication group in which the group calling and individual calling are performed.

Depending on the particular facility in which the communication system according to Embodiment 1 is installed, the facility can be classified into a plurality of divisions for facility management. In an example of an accommodation facility, bellpersons (porters), concierges, and housekeepers (cleaners) can be classified into different groups, and the communication environment can be established such that hotel room management is performed within each of those groups. In another viewpoint, communications may not be required for some tasks. For example, serving staff members and bellpersons (porters) do not need to directly communicate with each other, so that they can be classified into different groups. In addition, communications may not be required from geographical viewpoint. For example, when a branch office A and a branch office B are remotely located and do not need to frequently communicate with each other, they can be classified into different groups.

The communication control section 112 of the management apparatus 100 includes a group calling control section 112A, an individual calling control section 112B, and a calling mode coordination section 112C.

The group calling control section 112A includes a first control section and a second control section. The first control section controls broadcast of utterance voice data received from one user terminal 500 to the other user terminals 500. The second control section chronologically accumulates the result of utterance voice recognition from voice recognition processing on the received utterance voice data in the user-to-user communication history 123 and controls text delivery such that the communication history 123 is displayed in synchronization on all the user terminals 500 including the user terminal 500 of the user who performed the utterance.

The function provided by the first control section is broadcast of utterance voice data. The utterance voice data mainly includes voice data representing user's utterance. When the voice synthesis function is included as described above, the synthesized voice data produced artificially from the text information input on the user terminal 500 is also broadcast by the first control section.

The function provided by the second control section is broadcast of the text resulting from the voice recognition of the user's utterance and the text used in producing the synthesized voice data. All the voices input to the user terminals 500 and reproduced on the user terminals 500 have their text versions which are accumulated chronologically in the communication history 123 and displayed on the user terminals 500 in synchronization. The voice recognition section 113 performs voice recognition processing with the voice recognition dictionary 124 and outputs text data as the result of utterance voice recognition. The voice recognition processing can be performed by using any of known technologies.

The communication history information 123 is log information including contents of utterance of the users, together with time information, accumulated chronologically on a text basis. Voice data corresponding to each of the texts can be stored as a voice file in a predetermined storage region, and the position of the stored voice file is recorded in the communication history 123, for example. The communication history information 123 is created and accumulated for each communication group.

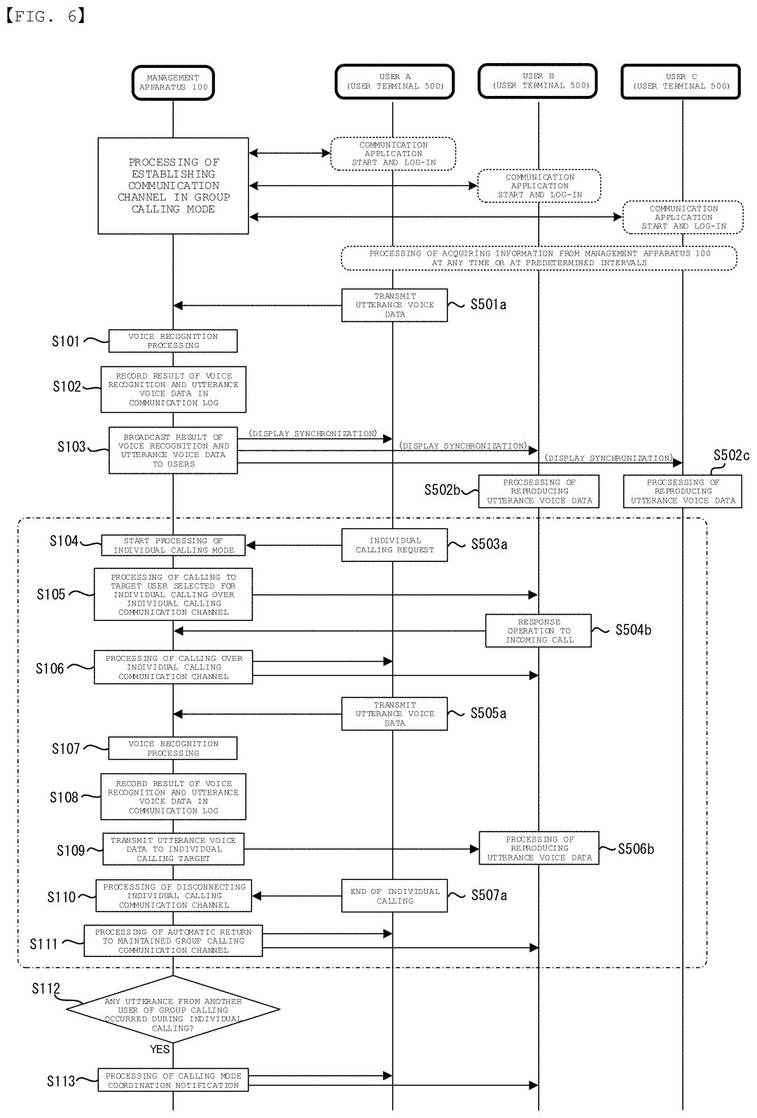

FIG. 4 is a diagram showing an example of the communication history 123 displayed on the user terminals 500. Each of the user terminals 500 receives the communication history 123 from the management apparatus 100 in real time or at a predetermined time, and the display thereof is synchronized among the users. The users can chronologically refer to the communication log.

As in the example of FIG. 4, each user terminal 500 chronologically displays the utterance content of the user of that terminal 500 and the utterance contents of the other users in a display field D to share the communication history 123 accumulated in the management apparatus 100 as log information. In the display field D, each text representing user's own utterance may be accompanied by a microphone mark H, and the users other than the utterer may be shown by a speaker mark M instead of the microphone mark H in the display field D.

The individual calling control section 112B provides the individual calling function of transmitting utterance voice data only to specified users of the users within the communication group in which broadcast is performed during the group calling.

The management apparatus 100 can create a list of group members including the plurality of users registered in the communication group and deliver the list to the user terminals 500 in advance. In response to selectin of a target user for individual calling from the list of group members, the user terminal 500 transmits an individual calling request including the selected user to the management apparatus 100.

As described above, to allow a user to make a one-to-one call to another user during the group calling mode, the individual calling control section 112B performs call processing of originating a call to a selected user. The call processing is an interrupt to the ongoing group calling mode. When the selected user responds to the call processing, the individual calling control section 112B performs call connection processing (processing of establishing an individual calling communication channel). Through the established calling channel, the individual calling control section 112B starts processing of transmitting utterance voice data between the individual calling users. The processing described above is performed as an individual calling interrupt for allowing a call between two specified users separately from the other users of the communication group while group calling is maintained in the communication group.

At any time other than in the group calling mode, the individual calling control section 112B can receive an individual calling request from one of the user terminals 500 and establish an individual calling channel to a selected user to provide the function of one-to-one calling.

After the individual calling, automatic return processing can be performed to return to the group calling mode maintained in the communication group. The automatic return processing is performed by the communication control section 112. In response to operation for terminating the individual calling mode on the user terminal 500, the communication control section 112 performs processing of disconnecting the established individual calling channel to automatically return to the channel of the ongoing group calling mode.

Calling time information in the individual calling mode (including the call start time, call duration after the response to the call, and the call end time) is accumulated in the management apparatus 100 as a history of individual calling mode executions for each user together with a history of called parties of individual calling. Utterance voice data during the individual calling can be converted into text through voice recognition processing and stored in the communication history information 123 or elsewhere in association with the time axis of the communication history information 123, similarly to utterance voice data in the group calling mode. The utterance voice data during the individual calling mode can also be stored in the storage apparatus 120.

FIG. 5 is a diagram for explaining exemplary calling mode coordination processing performed during the group calling mode in response to an interrupt for the individual calling mode.

After the end of the individual calling mode, the calling mode coordination section 112C performs processing of notifying two participant users in the individual calling mode that utterances (broadcast) in the group calling occurred during the individual calling mode. The calling mode coordination section 112C can identify the users participating in the individual calling mode in which utterance voice data is transmitted only to specified users, during the broadcast of the first control processing performed by the group calling control section 112A.

For example, the user terminal 500 operating in the individual calling mode cannot reproduce utterance voice data broadcast in the group calling. As described above, utterance voice data transmitted through the group calling channel cannot be received during the individual calling mode. The communication application control section 520 of the user terminal 500 transmits, to the management apparatus 100, a message indicating that the user terminal 500 cannot receive utterance voice of the group calling during the individual calling.

In communication environments having poor reception of radio waves, communication may fail. The system according to Embodiment 1 can distinguish between the inability to receive utterance voice of the group calling due to disconnected communication channels resulting from such communication failures and the inability to receive utterance voice since the user terminal 500 is in the individual calling mode.

When utterance voice cannot be received due to the changed communication state, the communication channel is disconnected, that is, the session is disconnected, so that the status of communication with the user terminal 500 is “communication error.” The communication error prevents the management apparatus 100 from receiving the message indicating that the user terminal 500 cannot receive utterance voice data of group calling, and accordingly no response from the user terminal 500 is present. Thus, when no response is present, the management apparatus 100 can determine that the communication channel within the communication group is disconnected, or when any response is present, the management apparatus 100 can determine that individual calling is currently performed.

The “history of the inabilities to receive utterance voice of group calling” corresponds to a history of utterance voices of group calling during individual calling. After the end of individual calling, the calling mode coordination section 112C refers to such a history of the inabilities to receive utterance voice accumulated for each user, if any, and performs processing for notifying the user having the history that utterances (broadcast) of the group calling occurred during the individual calling mode.

The processing for notifying the user that utterances (broadcast) of the group calling occurred during the individual calling mode is, for example, processing of transmitting a signal for controlling the operation of the vibration apparatus 570 to the user terminal 500 of that user. This can cause the user terminal 500 to operate the vibration apparatus 570 based on the received operation control signal, thereby notifying the user of the hands-free user terminal 500 of the group calling utterance during the individual calling that the user was not able to hear.

In addition to the vibration function of the user terminal 500, various sounds may be used to give notice to the user (for example, sounds from alarm clocks (bleep) or buzzer sounds).

The notification may be performed at any time after the end of the individual calling. For example, the notification may be sent along with the end of the individual calling mode. Specifically, at the time of automatic return to the group calling mode in the automatic return processing, the management apparatus 100 determines whether or not there is any content of the group calling that the user participating in the individual calling was not able to hear, and when such a content is present, the management apparatus 100 can perform processing of reconnecting to the group calling communication channel in the automatic return and perform the notification processing through the group calling channel once the reconnection is made. Alternatively, the management apparatus 100 may be configured to automatically output such a notification a predetermined time period, for example 15 seconds, after the automatic return.

Upon being notified of the utterance (broadcast) of the group calling during the individual calling mode, the user can see the communication history (see FIG. 4) displayed in synchronization on the user terminals 500 to know the content of the group calling that the user was not able to hear.

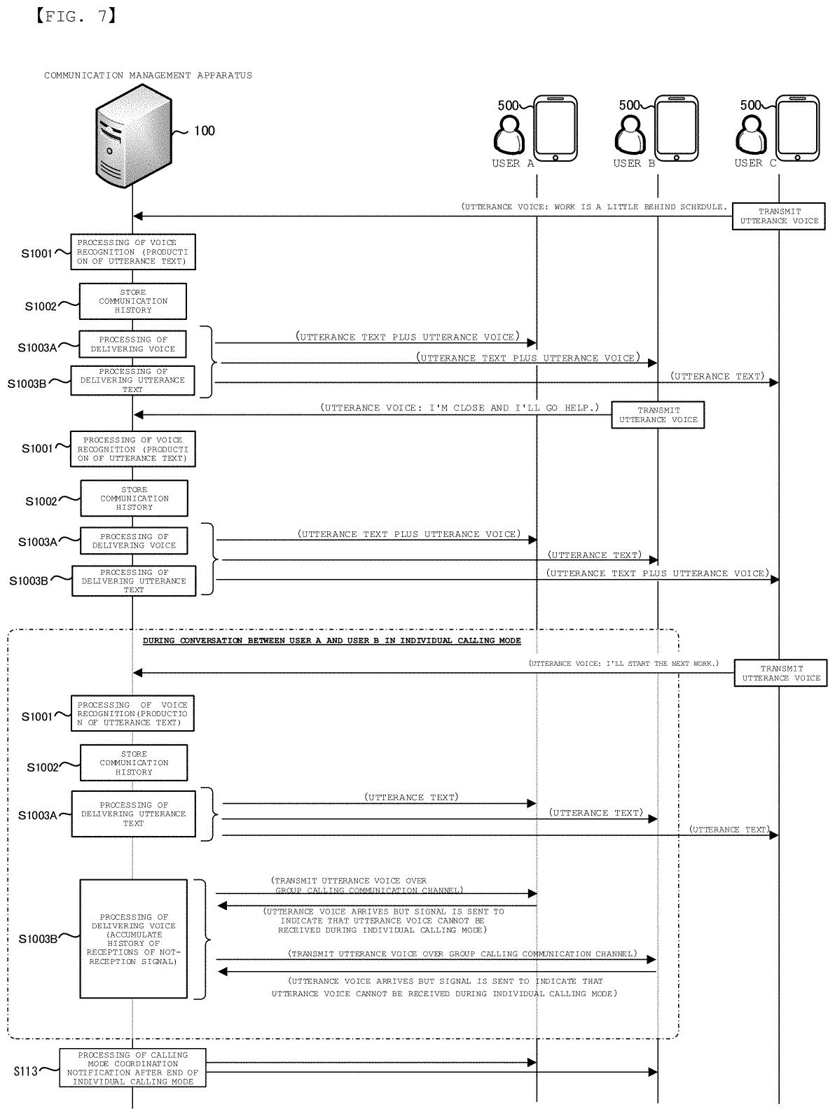

FIG. 6 is a diagram showing a flow of processing performed in the communication system according to Embodiment 1.

Each of the users starts the communication application control section 520 on his user terminal 500, and the communication application control section 520 performs processing for connection to the management apparatus 100. Each user enters his user ID and password on a predetermined log-in screen to log in to the management apparatus 100. The log-in authentication processing is performed by the user management section 111. At the second and subsequent log-ins, the input operation of the user ID and password can be omitted since the started communication application control section 520 can automatically perform log-in processing with the user ID and password input by the user at the first log-in.

After the log-in, the management apparatus 100 automatically performs processing of establishing a communication channel in a group calling mode with each of the users to open a group calling channel centered around the management apparatus 100.

After the log-in, each user terminal 500 performs processing of acquiring information from the management apparatus 100 at any time or at predetermined intervals.

When a user A performs utterance, the communication application control section 520 collects the voice of that utterance and transmits the utterance voice data to the management apparatus 100 (S501a). The voice recognition section 113 of the management apparatus 100 performs voice recognition processing on the received utterance voice data (S101) and outputs the result of voice recognition of the utterance content. The communication control section 112 stores the result of voice recognition in the communication history 123 and stores the utterance voice data in the storage section 120 (S102).

The communication control section 112 broadcasts the utterance voice data of the user A, who performed the utterance, to the user terminals 500 of the users other than the user A. The communication control section 112 also transmits the utterance content (in text form) of the user A stored in the communication history 123 to the user terminals 500 of the users within the communication group including the user A for display synchronization (S103).

The communication application control sections 520 of the user terminals 500 of the users other than the user A perform automatic reproduction processing on the received utterance voice data to output the reproduced utterance voice (S502b, S502c), and displays the utterance content of text form corresponding to the output reproduced utterance voice in the display field D.

During the group calling mode in which the users participate, the user A can select a user to whom he wishes to make a one-to-one call from the list of group members and perform individual calling. An individual calling request including the user (for example, a user B) selected for individual calling is transmitted from the user terminal 500 of the user A to the management apparatus 100 (S503a).

Upon reception of the individual calling request, the management apparatus 100 performs individual calling mode (interrupt) processing (S104). Specifically, the management apparatus 100 performs call processing to the selected user B through an individual calling communication channel (S105). The user B performs response operation to the incoming call (S504b). Once the user B performs the operation for responding to the incoming call, the management apparatus 100 performs calling processing for establishing an individual calling line between the user A and the user B through the individual calling communication channel (S106). After the transition to the individual calling mode, the two users are treated in the same manner as “on hold” from the viewpoint of the group calling channel, and can automatically return to the group calling communication channel after the end of the individual calling, as later described.

When the user A performs utterance, the communication application control section 520 collects the voice of that utterance and transmits the utterance voice data to the management apparatus 100 (S505a). The voice recognition section 113 of the management apparatus 100 performs voice recognition processing on the received utterance voice data (S107) and outputs the result of voice recognition of the utterance content. The communication control section 112 stores the result of voice recognition in the communication history 123 and stores the utterance voice data in the storage section 120 (S108). The content of the individual calling is stored in the communication history 123 is accumulated such that utterances of the individual calling mode can be distinguished from utterances of the group calling mode.

The communication control section 112 transmits the utterance voice data of the user A only to the user terminal of the user B corresponding to the individual calling target (S109). The communication application control section 520 of the user terminal 500 of the user B performs automatic reproduction processing on the received utterance voice data to output the reproduced utterance voice (S506b).

Upon reception of an individual calling end command produced in operation for disconnecting the call between the user A and the user B (S507a), the management apparatus 100 performs processing of disconnecting the individual calling channel (S110). With the processing of disconnecting the individual calling channel as a trigger, the management apparatus 100 performs processing of automatically returning to the communication channel for the group calling mode which has been put “on hold” from the viewpoint of the two users participating in the individual calling (S111).

The management apparatus 100 performs calling mode coordination processing by determining whether or not any utterance from another user of the group calling occurred during the individual calling (S112). When the management apparatus 100 determines that there was any utterance voice of the group calling that the two users were not able to hear during the individual calling (YES at S112), the management apparatus 100 performs, at a predetermined time after the return to the group calling mode (including immediately after the return), notification processing of notifying each of the two users that there was the utterance voice of the group calling that the users were not able to hear during the individual calling (S113).

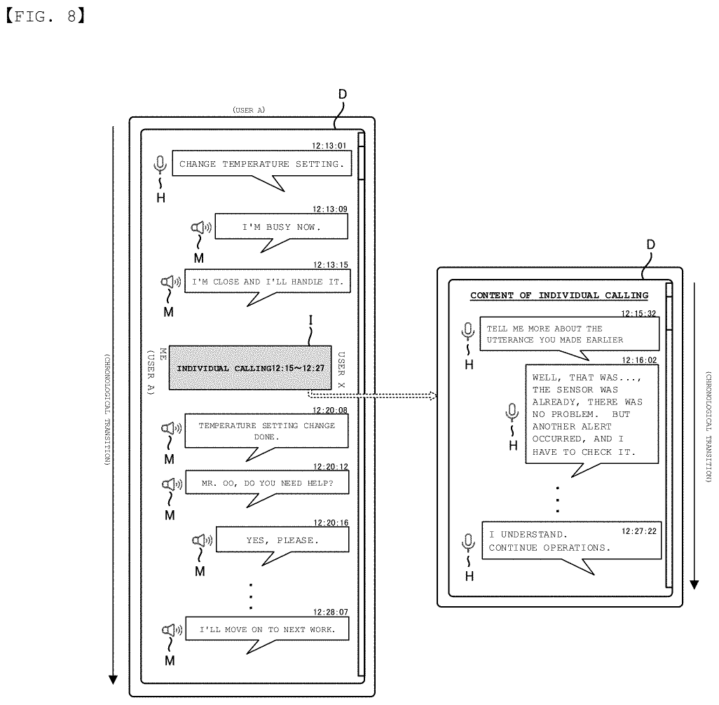

FIG. 7 is a diagram showing a flow of processing based on a first case performed in the communication system according to Embodiment 1.

As shown in FIG. 7, when a user C says “Work is a little behind schedule” in the group calling mode, the communication application control section 520 collects the voice of that utterance and transmits the utterance voice data to the management apparatus 100. The voice recognition section 113 of the management apparatus 100 performs voice recognition processing on the received utterance voice data (1001) and outputs the result of voice recognition of the utterance content. The communication control section 112 stores the result of voice recognition in the communication history 123 and stores the utterance voice data in the storage section 120 (S1002).

The communication control section 112 broadcasts the utterance voice data of the user C, who performed the utterance, to the user terminals 500 of the users other than the user C (1003A). The communication control section 112 also transmits the utterance content “Work is a little behind schedule” from the user C stored in the communication history 123 to the user terminals 500 of the users within the communication group including the user C for display synchronization (S1003B).

When the user B says “I'm close and I'll go help” in response to the utterance of the user C, the management apparatus 100 performs operations from steps S1001 to S1003B by performing voice recognition processing on the received utterance voice data of the user B, outputting the result of voice recognition of the utterance content, storing the result of voice recognition in the communication history 123, and broadcasting the utterance voice data of the user B, who performed the utterance, to the user terminals 500 of the users other than the user B. The management apparatus 100 also transmits the utterance content “I'm close and I'll go help” from the user B stored in the communication history 123 to the user terminals 500 of the users with the communication group including the user B for display synchronization.

Then, the user A and the user B of the users participating in the group calling mode start individual calling, for example. When the user C says “I'll start the next work” in the group calling mode, the management apparatus 100 performs operations from step S1001 to S1003B by performing voice recognition processing on the received utterance voice data of the user C, outputting the result of voice recognition of the utterance content, and storing the result of voice recognition in the communication history 123.

The management apparatus 100 broadcasts the utterance voice data of the user C, who performed the utterance, to the user terminals 500 of the users including the user A and the user B other than the user terminal of the user C, and transmits the utterance content “I'll start the next work” from the user C stored in the communication history 123 to the user terminals 500 of the users A and B during the individual calling, and the user C, for display synchronization.

As shown in FIG. 7, the management apparatus 100 transmits the utterance voice data of the group calling mode to the users including the users A and B participating in the individual calling. In response, however, each of the user terminals 500 of the users A and B transmits a message (signal) indicating that it cannot receive the utterance voice of the group calling during the individual calling to the management apparatus 100.

As described above, even when the individual calling interrupt is present, the management apparatus 100 processes the utterance voice of the group calling by the first control section broadcasting the utterance voice data and the second control section converting the utterance voice into text and the delivering the text to the users without excluding the two users participating in the individual calling. The management apparatus 100 can recognize the presence or absence of any utterance of the group calling that the two users were not able to hear. Thus, the management apparatus 100 can perform the processing of calling mode coordination notification after the end of the individual calling (see FIG. 6).

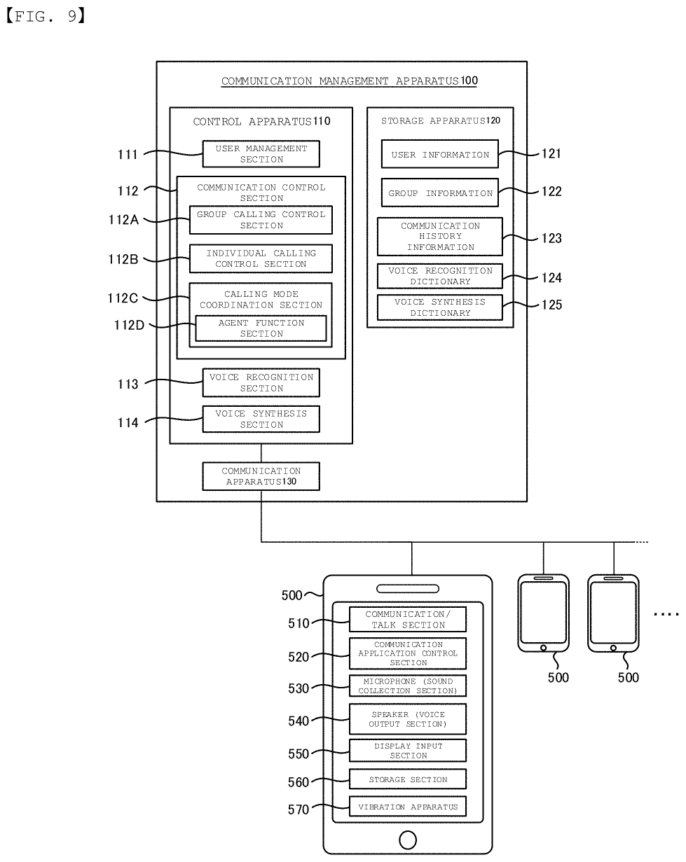

FIG. 8 is a diagram showing exemplary display of an individual calling history.

The individual calling control section 112B can chronologically accumulate the history of executions of the individual calling mode as described above. The group calling control section 112A can perform processing with the second control section (second processing) on the history of executions of the individual calling mode to display the history of executions of the individual calling mode in synchronization on the user terminals 500 of the communication group.

In the example of FIG. 8, a text box I is displayed as part of the history of the communication group to show that the user A and the user B performed individual calling from 12:15 to 12:27. This allows each of the users of the communication group to recognize who performed individual calling with whom.

As described above, the individual calling control section 112B can chronologically accumulate the individual calling utterance text provided through voice recognition processing on the utterance voice data during the individual calling mode or the individual calling utterance text providing the utterance voice data through voice synthesis processing during the individual calling mode. In response to operation on the text box I displaying the history of executions of the individual calling, for example, selection of the text box I or selection of an button for displaying the individual calling content, not shown, the group calling control section 112 can extract the individual calling utterance text corresponding to the selected execution history, and provide and display the extracted text on the user terminal 500.

In this manner, the text delivery can be controlled to display the calling content of the individual calling mode (individual calling utterance text) on each user terminal 500. The communication control section 112 can control access to the calling content of the individual calling mode for each user. For example, the communication control section 112 can perform control such that administrators or managers in charge of management can view the contents of individual calling between the other users, but the users other than those in charge of management can view only the contents of their own individual calling and cannot view the contents of individual calling between the other users.

### Embodiment 2

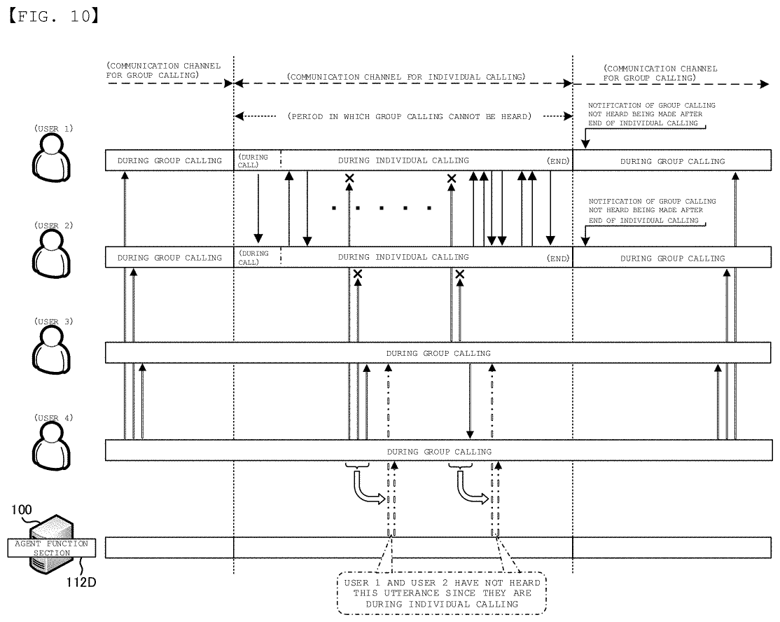

FIGS. 9 to 12 are diagrams for explaining Embodiment 2. FIG. 9 is a block diagram showing the configurations of the communication management apparatus and the user terminal according to Embodiment 2. Embodiment 2 differs from Embodiment 1 in that Embodiment 2 includes an agent function section 112D. It should be noted that, in the following description, the components having the same functions as those in Embodiment 1 are designated with the same reference numerals and their description is omitted.

FIG. 10 is a diagram for explaining exemplary calling mode coordination processing performed during a group calling mode in response to an interrupt for an individual calling mode according to Embodiment 2. In the example of FIG. 10, the agent function section 112D provides a function of notifying the presence of any user participating in individual calling who has not heard voice of utterance performed in the group calling mode.

Specifically, the agent function section 112D (communication control section) determines the presence or absence of any user participating in the individual calling mode in which utterance voice data is transmitted only to specified users, during the broadcast of the first control section (first processing) by the group calling control section 112A. The user participating in the individual calling is identified similarly to Embodiment 1.

When the agent function section 112D determines that any user participating in the individual calling mode is present, the agent function section 112D produces an utterance text representing that the user determined to participate in the individual calling mode has not heard utterance voice data of the group calling mode in which the broadcast (first processing) is being performed. For example, the agent function section 112D can the utterance text by putting the name of the identified user in a prepared fixed phrase “Mr. OO and Mr. □□ are during individual calling and have not heard this utterance.”

The group calling control section 112A performs voice synthesis processing based on the utterance text produced by the agent function section 112D and notifying the presence of the user within the communication group who has not heard utterance of the group calling. The group calling control section 112A broadcasts the synthesized voice data of the utterance text.

In this manner, the agent function section 112D can recognize the user who has not heard or cannot hear utterance of a user who performed the utterance in the group calling mode.

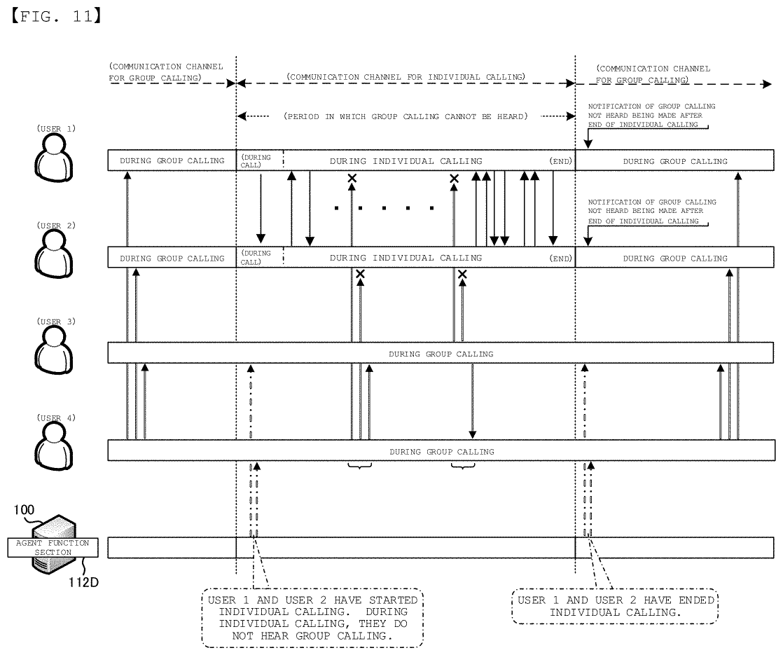

Next, FIG. 11 is a diagram for explaining another exemplary calling mode coordination processing performed during the group calling mode in response to an interrupt for the individual calling mode according to Embodiment 2.

The example of FIG. 11 illustrates a mechanism in which the start and the end of individual calling are notified to the users within the communication group other than the users participating in the individual calling mode. For example, as described above, the start and end of the individual calling are recorded as a log, and the agent function section 112D (communication control section 112) can produce a notification utterance text for notifying the start of the individual calling mode when the individual calling control section 112B starts the individual calling mode. For example, the agent function section 112D can produce a notification utterance text “User 1 and user 2 have started individual calling. During individual calling, they do not hear group calling.” The users participating in the individual calling are identified as described above. Whether the individual calling has been started or not can be determined from call processing or establishment of an individual calling channel associated with the call processing.

When the individual calling control section 112B ends the individual calling mode, the agent function section 112D can also produce a notification utterance text for notifying the end of the individual calling mode. For example, the agent function section 112D can produce a notification utterance text “User 1 and user 2 have ended individual calling.” The users participating in the individual calling are identified as described above. Whether the individual calling has been ended or not can be determined from processing of disconnecting the individual calling channel or processing of automatically returning to the group calling channel.

The notification utterance text (text for notifying the start of the individual calling and/or the end of the individual calling) produced by the agent function section 112D is output to the group calling control section 112A. The voice synthesis section 114 performs voice synthesis processing on the notification utterance text to provide synthesized voice data, and the group calling control section 112A broadcasts the synthesized voice data to the users within the communication group.

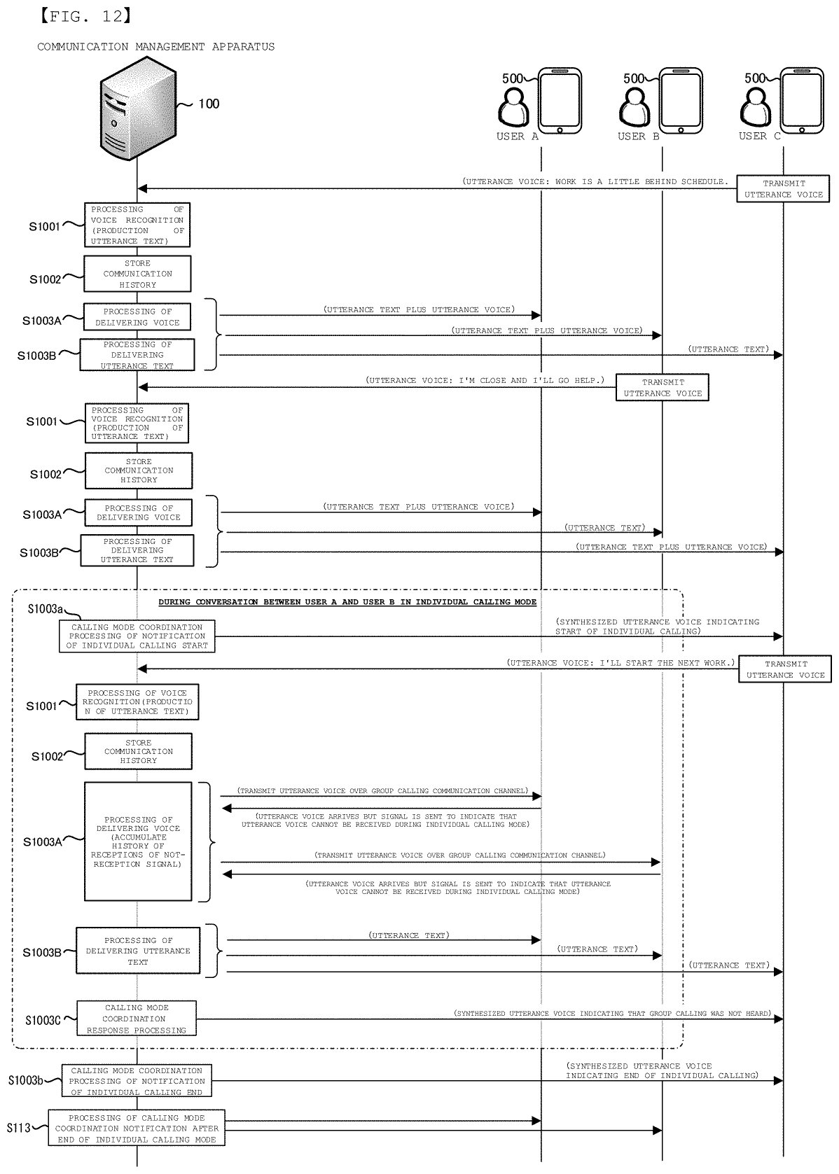

FIG. 12 is a diagram showing a flow of processing based on a second case performed in the communication system according to Embodiment 2. It should be noted that the same operations as those in FIG. 7 according to Embodiment 1 are designated with the same reference numerals and their description is omitted.

As shown in FIG. 12, when individual calling control section 112B starts the individual calling mode between the user A and the user B (including call processing), the agent function section 112D performs the processing of notification of individual calling start described above as the calling mode coordination processing (S1003a). The agent function section 112D also performs the processing of notification of individual calling end described above as the calling mode coordination processing (S1003b).

When any utterance is performed in the group calling mode during the individual calling, the agent function section 112D can perform the calling mode coordination processing by notifying the presence of the user participating in the individual calling who has not heard the voice of the utterance performed in the group calling mode (S1003C) to notify the users other than the user participating in the individual calling.

The notification indicating that the user has not heard the utterance of the group calling and the notifications indicating that the individual calling has been started and the individual calling has been ended in Embodiment 2 can be combined in any manner as the coordination processing performed in association with the individual calling within the communication group. For example, the system according to Embodiment 2 can have all the notification functions, only the function of notification indicating that the user has not heard the utterance of the group calling, or both the function of notification indicating that the user has not heard the utterance of the group calling and the function of notification indicating that the individual calling has been ended.

### Embodiment 3

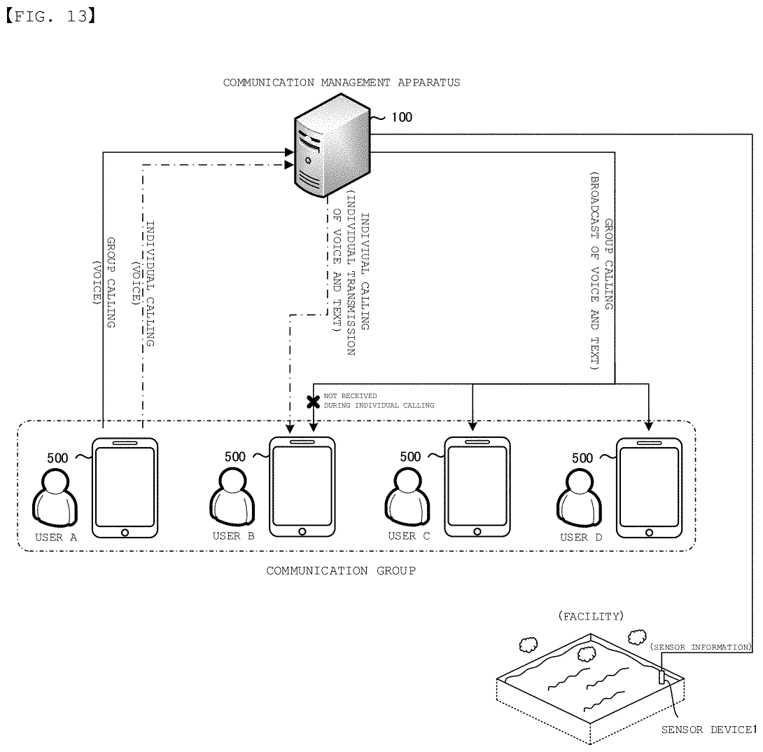

FIGS. 13 to 15 are diagrams for explaining Embodiment 3. FIG. 13 is a diagram showing the configuration of a network of a communication system according to Embodiment 3. Embodiment 3 differs from Embodiment 1 and Embodiment 2 in that Embodiment 3 includes a mechanism for using an individual calling function to notify a specified user of a predetermined condition being satisfied or of information about any event that may occur or has been occurred on the predetermined condition being satisfied. It should be noted that, in the following description, the components having the same functions as those in Embodiment 1 or 2 are designated with the same reference numerals and their description is omitted.

For example, the management apparatus 100 can receive sensor information output from a sensor device 1. In the example of FIG. 13, a temperature sensor is shown as an example of equipment for use in a facility such as a bathhouse. The sensor device 1 is a device which monitors the state of a monitoring target and can have a communication function. The sensor device 1 transmits the detected sensor information to the management apparatus 100 through a wireless channel or a wired line.

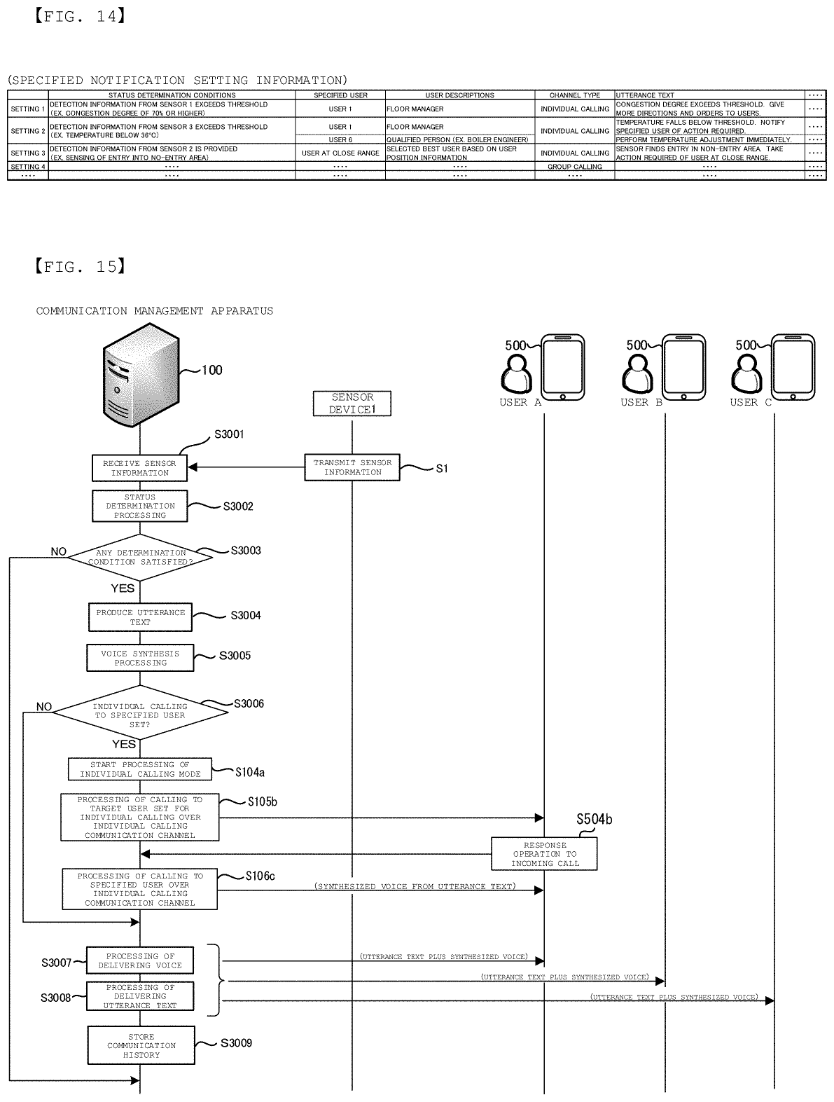

FIG. 14 is a diagram showing exemplary specified notification setting information. As shown in FIG. 14, status determination conditions are set, and for each of the conditions, at least one user is specified to make contact through individual calling, and the content to be transmitted (utterance text) is also preset.

FIG. 15 is a diagram showing a flow of processing based on a third case performed in a communication system according to Embodiment 3.

The sensor device 1 transmits sensor information to the management apparatus 100 at a predetermined time (S1). The management apparatus 100 receives the sensor information (S3001), and the agent function section 112D performs specified notification determination processing (S3002). Specifically, the agent function section 112D receives the detection information output from the temperature sensor (state detection device) for the monitoring target, matches the information with the “status determination conditions” of the specified notification setting information, and determines whether or not the received detection information satisfies any of the status determination conditions (S3003). In response to determination that the information satisfies any of the status determination conditions, the management apparatus 100 extracts (produces) the associated preset utterance text (S3004), and the voice synthesis section 114 produces synthesized voice data of the extracted utterance text (S3005).

Next, the agent function section 112D refers to the specified notification setting information in FIG. 14 to identify the channel type and the specified user to be notified (S3006). When the matched status determination condition specifies that the setting of individual calling to any specified user is “present,” the individual calling control section 112B performs individual calling mode (interrupt) processing on that specified user in the current group calling mode (S104a). Specifically, the individual calling control section 112B performs call processing to the specified user through an individual calling communication channel (S105b). Upon reception of the call, the user performs response operation to the incoming call (S504b). Once the specified user performs the operation for responding to the incoming call, the management apparatus 100 performs calling processing for establishing an individual calling line between the agent function section 112D and the specified user through the individual calling communication channel (S106c). The agent function section 112D delivers the synthesized voice data to the user terminal 500 of the specified user over the individual calling line.

After the transition to the individual calling mode, the specified user is treated in the same manner as “on hold” from the viewpoint of the group calling channel, and can automatically return to the group calling communication channel after the end of the individual calling.

When the group calling mode is set as the channel type at step S3006, the management apparatus 100 performs notification processing in the group calling mode instead of the individual calling mode. Specifically, when the sensor information matches any of the predetermined conditions, the management apparatus 100 can broadcast the synthesized voice data and the utterance text to all the users within the communication group (S3007, S3008).

The communication control section 112 stores, in the communication history 123, the history of notifications to the specified user of the individual calling mode based on the detection information received from the sensor device 1 and the history of operations in the group calling mode (S3009).

As shown in FIG. 14, the specified user can include two or more users. In this case, individual calling channels to those specified users can be separately established, and synthesized voice data based on an utterance text can be delivered to each of the users. Different utterance texts can be set for the specified users. Specifically, as shown in the example of FIG. 14, an utterance text “Temperature falls below threshold. Notify specified user of action required” can be set for a floor manager, and an utterance text “Perform temperature adjustment immediately” can be set for a qualified person (for example, boiler engineer). The floor manager and the qualified person are provided with synthesized voice data based on the different utterance texts under the same status determination condition.

The specified user may not be a preset user. As shown in the example of FIG. 14, the position information of each user (user terminal) can be acquired, and when an event results from any of the status determination conditions being satisfied, one user or at least two users close to the site of the event can be determined as a specified user who should deal with the event. In the example of FIG. 14, when entry into a no-entry area is sensed, a specified user is selected based on the user position information, and synthesized voice data of an utterance text “Sensor finds entry into no-entry area. Take action required of user at closer range” can be transmitted to the selected specified user.

The exemplary aspect has been described in which the management apparatus 100 includes the agent function section 112D. Alternatively, an agent apparatus, not shown, connected to the sensor device 1 may hold the specified notification setting information shown in FIG. 14, perform matching with the status determination conditions, specify the notification channel type and the specified user, and transmit the associated utterance text and the individual calling request to the management apparatus 100. In other words, the agent function section 112D may be included as a member of the communication group, and an agent apparatus, not shown, may perform utterance in accordance with detection information as a group user.

Various embodiments of the present invention have been described. The functions of the communication management apparatus 100 and the agent apparatus 300 can be implemented by a program. A computer program previously provided for implementing the functions can be stored on an auxiliary storage apparatus, the program stored on the auxiliary storage apparatus can be read by a control section such as a CPU to a main storage apparatus, and the program read to the main storage apparatus can be executed by the control section to perform the functions.

The program may be recorded on a computer readable recording medium and provided for the computer. Examples of the computer readable recording medium include optical disks such as a CD-ROM, phase-change optical disks such as a DVD-ROM, magneto-optical disks such as a Magnet-Optical (MO) disk and Mini Disk (MD), magnetic disks such as a floppy disk® and removable hard disk, and memory cards such as a compact flash®, smart media, SD memory card, and memory stick. Hardware apparatuses such as an integrated circuit (such as an IC chip) designed and configured specifically for the purpose of the present invention are included in the recording medium.

While various embodiments of the present invention have been described above, these embodiments are only illustrative and are not intended to limit the scope of the present invention. These novel embodiments can be implemented in other forms, and various omissions, substitutions, and modifications can be made thereto without departing from the spirit or scope of the present invention. These embodiment and their variations are encompassed within the spirit or scope of the present invention and within the invention set forth in the claims and the equivalents thereof.

### DESCRIPTION OF THE REFERENCE NUMERALS

1 SENSOR DEVICE

100 COMMUNICATION MANAGEMENT APPARATUS

110 CONTROL APPARATUS

111 USER MANAGEMENT SECTION

112 COMMUNICATION CONTROL SECTION

112A GROUP CALLING CONTROL SECTION

112B INDIVIDUAL CALLING CONTROL SECTION

112C CALLING MODE COORDINATION SECTION

112D AGENT FUNCTION SECTION

113 VOICE RECOGNITION SECTION

114 VOICE SYNTHESIS SECTION

120 STORAGE APPARATUS

121 USER INFORMATION

122 GROUP INFORMATION

123 COMMUNICATION HISTORY INFORMATION

124 VOICE RECOGNITION DICTIONARY

125 VOICE SYNTHESIS DICTIONARY

130 COMMUNICATION APPARATUS

500 USER TERMINAL (MOBILE COMMUNICATION TERMINAL)

510 COMMUNICATION/TALK SECTION

520 COMMUNICATION APPLICATION CONTROL SECTION

530 MICROPHONE (SOUND COLLECTION SECTION)

540 SPEAKER (VOICE OUTPUT SECTION)

550 DISPLAY INPUT SECTION

560 STORAGE SECTION

570 VIBRATION SECTION

D DISPLAY FIELD

I TEXT BOX

1. A communication system in which a plurality of users carry their respective mobile communication terminals and a voice of utterance of one of the users input to his mobile communication terminal is broadcast to the mobile communication terminals of the other users, comprising:
a communication control section including:
a group calling control section configured to perform first processing of broadcasting utterance voice data received from one of the mobile communication terminals to the other mobile communication terminals and second processing of chronologically accumulating a result of utterance voice recognition from voice recognition processing on the received utterance voice data as a communication history and controlling text delivery such that the communication history is displayed on the mobile communication terminals in synchronization; and
an individual calling control section configured to transmit utterance voice data only to a specified user included in a communication group in which the broadcast is performed,
wherein the communication control section is configured to identify a user participating in an individual calling mode that utterance voice data being transmitted only to the specified user during the broadcast of the first processing and to perform, after end of the individual calling mode, processing for notifying the identified user that the broadcast was performed during the individual calling mode.

2. The communication system according to claim 1, wherein the communication control section is configured to:
in response to selection of a specified user to whom the individual calling control section is to make a call in the individual calling mode during a group calling mode in which the first processing is performed, perform individual calling interrupt processing of establishing an individual calling channel to the selected specified user; and
after end of the individual calling mode, perform processing of disconnecting the individual calling channel to automatically return to a communication channel for the ongoing group calling mode.

3. The communication system according to claim 1, wherein the communication control section is configured to determine the presence or absence of a user participating in the individual calling mode that utterance voice data being transmitted only to the specified user during the broadcast of the first processing, and in response to determination of the presence of the user participating in the individual calling mode, to produce an utterance text indicating that the user has not heard utterance voice data of the group calling mode in which the first processing is performed, and
the group calling control section is configured to broadcast synthesized voice data of the utterance text produced through voice synthesis processing.

4. The communication system according to claim 1, wherein the communication control section is configured to produce a notification utterance text for notifying start of the individual calling mode at the time of the start of the individual calling mode in the individual calling control section, or to produce a notification utterance text for notifying end of the individual calling mode at the time of the end of the individual calling mode in the individual calling control section, and
the group calling control section is configured to broadcast synthesized voice data of the notification utterance text produced through voice synthesis processing.

5. The communication system according to claim 1, wherein the individual calling control section is configured to chronologically accumulate a history of executions of the individual calling mode, and
the group calling control section is configured to perform the second processing on the history of executions of the individual calling mode such that the history of executions of the individual calling mode is displayed on the mobile communication terminals in synchronization.

6. The communication system according to claim 1, wherein the individual calling control section is configured to chronologically accumulate individual calling utterance texts provided through voice recognition processing on utterance voice data during the individual calling mode or individual calling utterance text for providing utterance voice data through voice synthesis processing during the individual calling mode, and
the group calling control section is configured to control text delivery such that the individual calling utterance text is displayed on the mobile communication terminals.

7. The communication system according to claim 1, further comprising an agent section configured to receive detection information output from a state detection device provided for a monitoring target and to produce an utterance text based on the detection information,
wherein the communication control section is configured to determine a user to whom individual calling should be made based on the detection information, and
the individual calling control section is configured to perform individual calling control of transmitting synthesized voice data of the utterance text based on the detection information to the determined user, the synthesized voice data being produced through voice synthesis operation.

8. A program comprising instructions executable by a management apparatus connected through wireless communication to mobile communication terminals carried by their respective users, the management apparatus being configured to broadcast a voice of utterance of one of the users to the mobile communication terminals of the other users, wherein the instructions, when executed by the management apparatus, cause to management apparatus to provide:
a group calling function including first processing of broadcasting utterance voice data received from one of the mobile communication terminals to the other mobile communication terminals and second processing of chronologically accumulating a result of utterance voice recognition from voice recognition processing on the received utterance voice data as a communication history and controlling text delivery such that the communication history is displayed on the mobile communication terminals in synchronization;
an individual calling function of transmitting utterance voice data only to a specified user included in a communication group in which the broadcast is performed; and
a function including processing of identifying a user participating in an individual calling mode that utterance voice data being transmitted only to the specified user during the broadcast of the first processing and performing, after end of the individual calling mode, processing for notifying the identified user that the broadcast was performed during the individual calling mode.
